(19) United States
(12) Patent Application Publication
(10) Pub. No.: US 2009/0075591 A1
(43) Pub. Date: Mar. 19, 2009

(54) Communications Technologies

(76) Inventors: Graham Alexander Munro Murdoch, New South Wales (AU); Stuart Colin Littlechild, New South Wales (AU)

Correspondence Address: WINSTEAD PC, P.O. BOX 50784, DALLAS, TX, 75201, US

(21) Appl. No.: 11/667,525

(22) PCT Filed: Mar. 19, 2007
(86) PCT No.: PCT/AU07/00331

§ 371 Date: Jun. 29, 2007

(30) Foreign Application Priority Data
Mar. 20, 2006 (AU) 2006901428
May 10, 2006 (AU) 2006902447
Sep. 20, 2006 (AU) 2006905182

(51) Int. Cl. H04B 5/00; H04B 7/00; H04W 84/02

(52) U.S. Cl. 455/41.1; 455/41.2; 455/42; 455/260; 370/338

(57) ABSTRACT

A wireless communications device (124) including a first antenna (138) and oscillator means (140) for providing a carrier signal (110). There is further provided modulation means (142) for imposing a low level phase modulation on the carrier signal in accordance with a data signal to create a modulated signal, the modulation means (142) also for providing the modulated signal to the first antenna (138) for transmission. An exemplary application of the present invention is in respect of document management systems and methods of identification.

### FIELD OF INVENTION

The present invention relates to the field of communications and in particular to communications devices for personal and local area networks.

In addition to short range communications operating within a range of 0 to 100 mm, the present invention finds application in communications technologies operating within 0 to 0.2 m, 0 to 10 m and 0 to 50 m. The present invention embraces devices and methods including medical devices for internal implantation, and methods therefor, short range wireless local area networks and so forth.

### BACKGROUND ART

The discussion throughout this specification comes about due to a realisation of the inventors and/or the identification of certain prior art problems.

Several communications system technologies have been developed in response to an increasing variety of applications that employ either short range and/or very short range communications. While very short range communications do not have the same degree of applicability to computer area networks that make use of technologies such as Bluetooth and Wi-Fi, very short range communications technologies are expected to forge an ever increasing presence in the general area of wireless communications.

Near field communications technology as proposed by Sony and Royal Philips, hereinafter referred to as “SRP-NFC”, suffers from the considerable disadvantage of having to have relatively high signal strengths so that communicating wireless devices are able to receive and process signals, despite the presence of background noise.

A second problem with SRP-NFC is that the method of transmission generates wide band interference and efforts to reduce these interference levels reduce the efficiency of data transmission. In addition to the aforementioned problems the data rate of transmission can be severely limited by the bandwidth of the antenna circuits used for transmitting and receiving the signals. Furthermore, transmitting of data between devices interrupts the transmission of power and the wide band emissions caused by the transmitting of data may contravene government regulations in different countries.

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

An object of the present invention is to overcome or alleviate at least one problem associated with present communications devices or methods, or at least to provide the public with a useful choice.

### SUMMARY OF INVENTION

In a first aspect of embodiments described herein there is provided a short range wireless communications method and/or device, comprising providing a carrier signal; imposing a phase modulation on the carrier signal to create a modulated signal; providing the modulated signal to a wireless communications device; wherein the phase modulation on the carrier signal is in accordance with a phase deviation, where the phase deviation is in accordance with a data signal.

In comparison to prior art systems such as SRP-NFC, Bluetooth and WiFi, preferred arrangements of the present invention provide for short range wireless communications having a phase modulation imposed on a carrier signal where the phase deviation is in accordance with a data signal.

In arrangements of the invention, the following benefits may be provided:
the ability to use lower signal strengths in comparison to signal strengths proposed for similar arrangements such as SRP-NFC;
the ability to more readily meet regulations set by governments and governmental agencies;
the ability to transmit data at much higher data rates;
the ability to achieve even higher data rates by using multilevel phase modulation methods which provide higher data rates without extending the spectrum of the transmitted signal;
the advantage of being much less affected by the bandwidth of the transmitting and receiving antennas;
the advantage of having one device powered by another while continuing transmission without interruption;
the advantage of possibly improved prevention of covert monitoring of the authentication process;
the ability to operate several such systems in relatively close proximity without the systems interfering with each others operation.

In this regard is noted that the forms of the present invention obviate a number of problems associated with the use of the use of amplitude pulse position modulation (PPM) as used by SRF-NFC for transmitting data in which
the transmitted spectrum of PPM is much wider than the original data being transmitted;
the power transmitted is interrupted by the amplitude pulses (the antennas used to transmit and receive the amplitude pulses have a limited envelope rise and fall time caused by their finite bandwidth);
the rise and fall times limit the maximum rate that amplitude pulses can be transmitted and/or received.

In another aspect of embodiments described herein there is provided a method of and/or apparatus for short range wireless communications, comprising providing a carrier signal; imposing a phase modulation on the carrier signal, in accordance with a data signal containing data, to create a modulated signal; and transmitting the modulated signal from a first wireless communications device to a second wireless communications device, the second wireless communications device having means for determining the data contained within the data signal, from the modulated signal.

As would be apparent, a phase modulation on the carrier signal is used as a means of sending the data from the first wireless communications device to the second wireless communications device. The short range wireless communication may provide a personal area network communications technology. In other arrangements the short range wireless communication occurs over a local area network communications technology.

In a third aspect of embodiments described herein there is provided a method of and/or device or system for near field communications, comprising providing a carrier signal; imposing a low level phase modulation on the carrier signal, in accordance with a data signal containing data, to create a modulated signal; transmitting the modulated signal from a first wireless communications device; and controlling the modulated signal transmitted in order that the data contained within the data signal is not able to be extracted, due to noise, by a second wireless communications device when outside a 0.2 m radius.

In addition to personal and local area networks the present invention is applicable to near field communications. In arrangements advantageous alternatives to SRP-NFC are provided.

In a fourth aspect of embodiments described herein there is provided a method of and/or apparatus for demodulating a modulated signal received by a wireless communications device and deriving therefrom a data signal, comprising receiving the modulated signal, producing a first signal, the first signal being a local oscillator or a reference signal, demodulating the modulated signal using the local oscillator or reference signal to obtain an indicative data signal.

A first wireless device may for example be a computer terminal and a second wireless device may for example be a computer peripheral such as a USB mass storage device. In arrangements the computer terminal may demodulate a modulated signal, sent by an antenna of the USB mass storage device, using a local oscillator or reference signal.

In a fifth aspect of embodiments described herein there is provided a method of and/or apparatus for demodulating a modulated signal received by a wireless communications device and deriving therefrom a data signal, comprising receiving the modulated signal and inducing into an antenna of the device, an antenna voltage signal; amplifying the antenna signal; providing a portion of the amplified signal to a phase locked loop to filter off sidebands and create a first signal; and demodulating the data signal where the demodulation includes XORing the modulated signal and the first signal and filtering the XOR output to provide the indicative data.

Providing a portion of the portion of the amplified signal to a phase locked loop to filter off sidebands and create a first signal preferably serves to advantageously improve the accuracy of the indicative data. Of course other arrangements may also be provided.

In a sixth aspect of embodiments described herein there is provided a method of and/or apparatus for demodulating a modulated signal received by a wireless communications device and deriving there from a data signal, comprising receiving the modulated signal and inducing into an antenna of the device, an antenna voltage signal; amplifying the antenna signal; passing a portion of the amplified signal through a delay means and creating a first signal; and demodulating the data signal where the demodulation includes XORing the modulated signal and the first signal and filtering the XOR output to provide the indicative data.

In a seventh aspect of embodiments described herein there is provided a short range wireless communications method of and apparatus for communicating between a plurality of wireless communications devices in an area network, comprising providing a carrier signal; imposing a phase modulation on the carrier signal to create a modulated signal; providing the modulated signal to a first one of the wireless communications devices; the phase modulation on the carrier signal being in accordance with a phase deviation where the phase deviation is in accordance with a data signal; and thereafter transmitting the modulated signal from the first wireless communications device and receiving the modulated signal at a second one of the wireless communications devices.

With a particular application to area networks the invention allows for specialised technologies, having advantageous benefits, to be rolled out as an alternative to currently proposed area network technologies.

In an eighth aspect of embodiments described herein there is provided a wireless communications device comprising a first antenna, oscillator means for providing a carrier signal; and modulation means for imposing a low level phase modulation on the carrier signal in accordance with a data signal to create a modulated signal, the modulation means also for providing the modulated signal to the first antenna for transmission.

Such devices extend to computers and peripherals. Keyboards, mice, mass storage devices, joysticks, and audio head sets are advantageous examples. Currently some devices are manufactured with transmitters and receivers outputting relatively large wireless communications signals. The present invention provides an advantageous alternative.

In a ninth aspect of embodiments described herein there is provided a wireless communications transmitter adapted to send a short range wireless communication signal to a wireless communications device in an area network, comprising a first antenna; oscillator means for providing a carrier signal; modulation means for imposing phase modulation on the carrier signal to create a modulated signal; and for providing the modulated signal to the first antenna; characterized in that the modulation means imposes phase modulation on the carrier signal in accordance with a phase deviation where the phase deviation is in accordance with a data signal.

In a tenth aspect of embodiments described herein there is provided a wireless communications receiver adapted to receive data from a second wireless communications device, the first wireless communications device comprising a second antenna, and receiver means, adapted to derive a second signal indicative of a data signal received by the second antenna in the form of a modulated signal formed by imposing a low level phase modulation on a carrier signal in accordance with the data signal and transmitting the modulated signal from a first antenna.

In an eleventh aspect of embodiments described herein there is provided a wireless communications receiver adapted to receive a short range wireless communication in an area network, the device comprising an antenna adapted to receive the modulated signal and, in response thereto, produce a first signal, receiver means adapted to use a phase sensitive circuit to derive from the first signal an indicative data signal.

In a twelfth aspect of embodiments described herein there is provided a wireless communications device for an area network adapted to receive a modulated signal and derive therefrom a data signal, the device comprising an antenna adapted to receive the modulated signal and, in response thereto, produce a first signal, and receiver means adapted to use a phase sensitive circuit to derive from the first signal an indicative data signal.

In a thirteenth aspect of embodiments described herein there is provided a device for demodulating a modulated signal received by the device and deriving therefrom a data signal, the device comprising means for receiving the modulated signal and inducing into an antenna of the device, an antenna voltage signal, means for amplifying the antenna signal to create a first signal, and receiver means adapted to use a phase sensitive circuit to derive from the first signal an indicative data signal.

In a fourteenth aspect of embodiments described herein there is provided a wireless communications receiver adapted to receive a short range wireless communication in an area network, the device comprising an antenna adapted to receive the modulated signal and, in response thereto, produce a first signal, and receiver means adapted to derive from the first signal, a local oscillator signal used to demodulate the first signal and obtain an indicative data signal.

In a fifteenth aspect of embodiments described herein there is provided a wireless communications device for an area network adapted to receive a modulated signal and derive therefrom a data signal, the device comprising an antenna adapted to receive the modulated signal and, in response thereto, produce a first signal, and receiver means adapted to derive from the first signal, a local oscillator signal used to demodulate the first signal and obtain an indicative data signal.

In a sixteenth aspect of embodiments described herein there is provided a device for demodulating a modulated signal received by the device and deriving therefrom a data signal, the device comprising means for receiving the modulated signal and inducing into an antenna of the device, an antenna voltage signal, means for amplifying the antenna signal to create a first signal, means for providing a portion of the amplified signal to a phase locked loop to filter off sidebands and create a second signal, means for combining the first and second signal in a phase sensitive detector to create a third signal, and means for filtering the third signal to provide indicative data.

In a seventeenth aspect of embodiments described herein there is provided a wireless communications receiver adapted to receive a short range wireless communication in an area network, the device comprising an antenna adapted to receive the modulated signal and, in response thereto, produce a first signal, and receiver means adapted to derive from the first signal, a delayed version of the first signal used to demodulate the first signal and obtain an indicative data signal.

In a eighteenth aspect of embodiments described herein there is provided a wireless communications device for an area network adapted to receive a modulated signal and derive therefrom a data signal, the device comprising an antenna adapted to receive the modulated signal and, in response thereto, produce a first signal, and receiver means adapted to derive from the first signal, a delayed version of the first signal and obtain an indicative data signal.

In a nineteenth aspect of embodiments described herein there is provided a device for demodulating a modulated signal received by the device and deriving therefrom a data signal, the device comprising means for receiving the modulated signal and inducing into an antenna of the device, an antenna voltage signal, means for amplifying the antenna signal to create a first signal, means for passing another portion of the amplified signal through a delay means to create a second signal, means for combining the first and second signal in a phase sensitive detector to create a third signal, and means for filtering the third signal to provide indicative data.

In a twentieth aspect of embodiments described herein there is provided, in particularly but not exclusively limited to document management and/or office communications, method of and/or system for determining reproduction criteria for use in a document management apparatus or system, comprising associating a radio frequency device with a reproducible article; receiving information corresponding to the radio frequency device; and determining reproduction criteria based on the information.

Preferably, the communication is in accordance with methods and apparatus as disclosed herein. Preferably, the reproduction criteria serves to enable operation of the apparatus. Preferably, the reproduction criteria serves to disable operation of the apparatus. Preferably, the reproduction criteria serves to selectively enable or disable a reproduction process. Preferably, the reproduction criteria enables a reproduction of process between a paper form and an electronic form. Preferably, the reproduction of criteria enables a reproduction process between a first paper form and a second paper form. Preferably, determining the reproduction criteria based on the information comprises querying a policy database containing a plurality of policy reproduction rules. Preferably, the reproduction criteria enables a reproduction of process between a first paper form and a second paper form, the first paper form having associated to it the radio frequency component. Preferably, receiving information corresponding to the device comprises interrogating the first paper form when the first paper form is proximate a position for photocopying and enabling the reproduction process comprises selectively allowing the first paper form to be photocopied based upon the reproduction criteria. Preferably, the information comprises identification indicia. Preferably, if the device is tampered with, the device is rendered inoperative. Preferably, if the device is tampered with, notification and/or an alarm is activated.

In a twenty first aspect of embodiments described herein there is provided in particularly but not exclusively limited to document management and/or office communications, method of and/or a production process comprising determining reproduction criteria as disclosed herein, and operating a reproduction apparatus or system in accordance with the determination.

Preferably, the apparatus or system is a photocopier, fax, scanner printer and/or device with any combination thereof. Preferably, there is a further step of additionally providing a second tag on the reproduction and reproducing tag information in the second tag.

In a twenty second aspect of embodiments described herein there is provided in particularly but not exclusively limited to document management and/or office communications, method of and/or a device and/or document management apparatus for determining reproduction criteria for use in a document management apparatus, the device comprising: a receiver for receiving information corresponding to a radio frequency device that is associated with a reproducible article; and logic means for determining reproduction criteria based on the information.

Preferably, there is a control means for enabling a reproduction process based on the reproduction criteria. Preferably, there is a tamper evident means associated with the device or a component of the device. Preferably, there is an interrogator associated with the device as disclosed herein and which is adapted to communicate with the radio frequency device associated with the reproducible article. Preferably, the apparatus comprises a radio frequency device. Preferably, the radio frequency device of the apparatus becomes operable when in the proximity of the radio frequency device associated with the reproducible article. Preferably, the interrogator is remote from the device adapted to determine the reproduction criteria. Preferably, the control means enables the reproduction process such that the reproduction process operates between a paper form and an electronic form. Preferably, the control means enables the reproduction process such that the reproduction process operates between a first paper form and a second paper form. Preferably, the logic means for determining the reproduction criteria is adapted to determine the reproduction criteria based by querying a policy database containing a plurality of policy reproduction rules. Preferably, the control means enables the reproduction process such that the reproduction process operates between a first paper form and a second paper form, the first paper form having associated to it the radio frequency device. Preferably, the second paper form also has an associated radio frequency device. Preferably, the receiver for receiving information corresponding to a radio frequency device comprises an interrogator for interrogating the first paper form when the first paper form is proximate a position for photocopying and the control means selectively allows the first paper form to be photocopied based upon the reproduction criteria. Preferably, the apparatus is a photocopier, fax, scanner, and/or printer. Preferably, the interrogator is proximate the lid, feeder and/or platen cover of the apparatus.

Other aspects and preferred aspects are disclosed in the specification and/or defined in the appended claims, forming a part of the description of the invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Further disclosure, objects, advantages and aspects of the present application may be better understood by those skilled in the relevant art by reference to the following description of preferred embodiments taken in conjunction with the accompanying drawings, which are given by way of illustration only, and thus are not limitative of the present invention, and in which:

FIG. 1 is a schematic view of a system operating according to a preferred embodiment of the invention; and

FIG. 2 is detailed schematic view of the operation of the system shown in FIG. 1.

FIG. 3 is a schematic view of a system according to another embodiment of the invention;

FIGS. 4(a) and 4(b) are phasor diagrams for waveforms produced in accordance with an embodiment of the invention;

FIGS. 5(a) to 5(c) are frequency spectra associated with an embodiment invention;

FIGS. 6(a) and 6(b) respectively illustrate methods of encoding and decoding data according to an embodiment of the invention;

FIGS. 6(c), 6(d) and 6(e) respectively illustrate alternative methods of encoding and decoding data according to an embodiment of the invention;

FIG. 7(a) is a schematic illustration of a preferred circuit for encoding a data signal for transmission according to an embodiment of the invention;

FIG. 7(b) is a schematic illustration of a preferred circuit for encoding a data signal for transmission according to an embodiment of the invention;

FIG. 7(c) is a schematic illustration of another preferred circuit for encoding a data signal for transmission according to an embodiment of the invention; and

FIG. 8(a) is a schematic illustration of a preferred circuit for decoding a data signal according to an embodiment of the invention;

FIG. 8(b) is a schematic illustration of another preferred circuit for decoding a data signal according to an embodiment of the invention;

FIG. 8(c) is a schematic illustration of another preferred circuit for decoding a data signal according to an embodiment of the invention;

FIG. 9 illustrates an embodiment of the present invention,

FIG. 10 illustrates FIG. 9 in a computer network,

FIG. 11 illustrates aspects of the operation of the embodiment shown in FIGS. 9 and 10,

FIG. 12 illustrates further aspects of the operation of the embodiment shown in FIGS. 9 and 10;

FIG. 13 illustrates schematically another embodiment of the present invention,

FIG. 14 illustrates a further embodiment of the present invention; and

FIGS. 15 and 16 illustrate a method according to another embodiment of the invention.

### DETAILED DESCRIPTION

The subject matter of PCT application PCT/AU98/01077, filed Dec. 24, 1998 and entitled “A TRANSMITTER AND A METHOD FOR TRANSMITTING DATA”, the subject matter of Australian Provisional Application 2006901428 filed on 20 Mar. 2006 and entitled “Method, System and Apparatus for Document Management”, the subject matter of Australian Provisional Application 2006905182 filed on 20 Sep. 2006 and entitled “Method, System and Apparatus for Document Management”, are hereby wholly incorporated by reference.

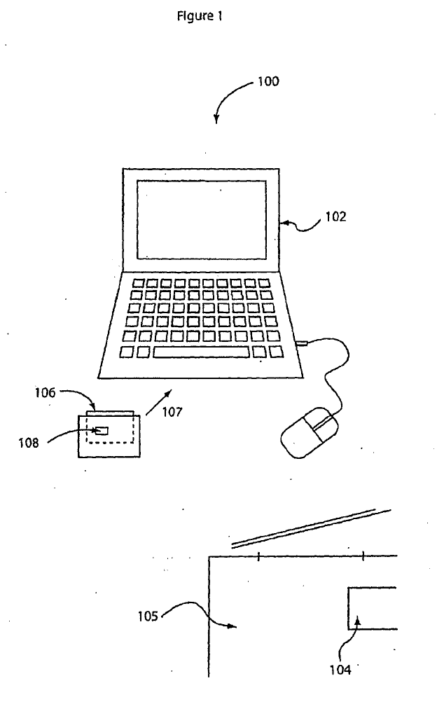

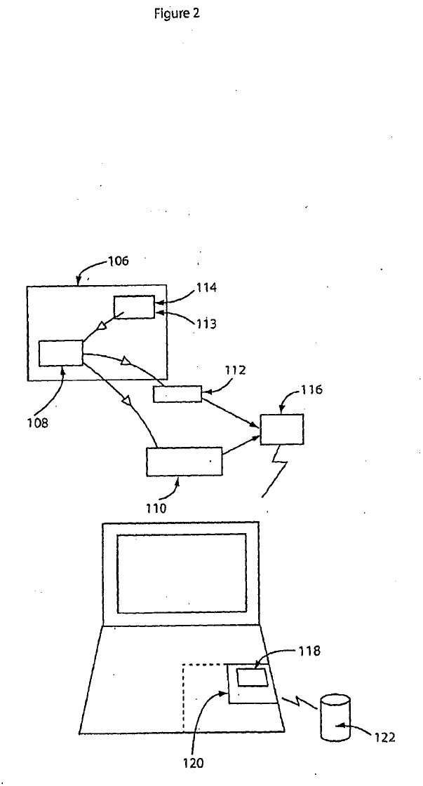

Referring to the FIGS. 1 and 2 there is shown a short range communications system 100. The short range communications system 100 operates on a 0 to 1 m range and is therefore accordingly associated with near field communications.

The system includes a computer terminal 102, a printer 104 and a data card 106. The data card 106 is sized and shaped to be held in a person's wallet.

The data card 106 allows connectivity to be achieved between the computer terminal 102 and the printer 104 using near field communications technology according to an embodiment of the invention.

In the embodiment, when a person does not have a data card 106 in the vicinity of their person, and operates the computer 102, an account of that person's activities is recorded and sent to the printer 104 for printing as a paper or electronic document. In order to ensure security, the printer 104 is located in a secured area 105.

In the situation where the person does have a data card 106 on their person, with sufficient authority, the data card 106 sends a transmission 107 to the computer 102 which thereafter initiates an authentication procedure which if successful disables the account of that person's activities being recorded.

The data card 106 commences a handshaking operation that is particularly advantageous due to the low signal strengths required. The operation commences with a transmitting circuit 108 on the data card 106 providing a carrier signal 110 onto which is imposed a phase modulation 112 in accordance with a data signal 113 containing data 114 representative of the authority provided by the data card 106. The resultant modulated signal 116 is transmitted from the data card 106 to the computer terminal 102.

An antenna circuit 118 in the computer terminal 102 is able to determine the data 114 contained within modulated signal 116. Following this a transmitter circuit 120 in the computer terminal 102 queries a database 122 to determine whether the data 114 provides the nearby data card 106 with sufficient authority to be able to use the computer terminal 102 without an account of the persons activities being sent to the printer 104.

Thus it will be apparent that the embodiment provides a contactless form of identification of the person's authority is accessed via the data card 106. In a variation on this embodiment the data card must be brought within 0.2 m of the computer terminal to prevent an account being generated. In this variation the modulated signal 116 is controlled such that the data 114 contained within the data signal 113 is not able to be extracted, due to background noise and interference, by the computer terminal 102 when the data card 106 is outside the 0.2 m radius. This serves to limit snooping of the data 114 by outside wireless communication sniffers so as to prevent duplication of the data 114 and unauthorized access.

Once the data 114 has been transferred to the computer terminal 102 further modulated signals sent between the data card 106 and the computer 102 are controlled such that further data is not able to be transmitted from the data card 106 outside a 5 m radius, as opposed to a 0.2 m radius. This enables the person to move away from the computer 102 to allow another person to operate the computer 102 in the first person's presence.

It is to be appreciated that the change in the signal strength of the further modulated signals 116 does not subject the data 114 to any further security hazard as the modulated signal after authentication merely contains data indicative of the person being in the vicinity of the computer 102. The longer range communication again imposes a phase modulation 112 on the carrier signal 110. This occurs without the need for Bluetooth communication technology or SRP-NFC. Advantageously the embodiment provides for lower signal strengths so as provide benefits possibly including the prevention of covert monitoring of the authentication process. In addition there is provided the ability to operate a number of such systems for different purposes relating to say a single person in relatively close proximity without the systems interfering with each others operation.

It is to be appreciated that while data cards in some of the examples herein described cannot transmit a low level phase modulated carrier, also known as a Phase Jitter Modulation (PJM) signal, but only receive it and transmit an RF reply, they may indeed be able to do so in the future with improved power source arrangements. Personal Digital Assistant's (PDA's) can, on the other hand presently transmit PJM because they have a suitable power source.

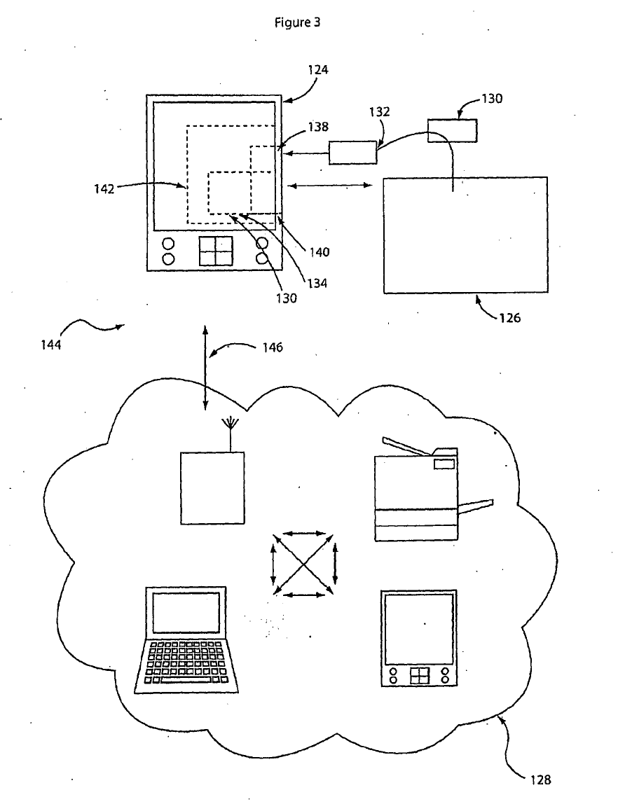

In another embodiment of the invention shown in FIG. 3 a first wireless communications device in the form of a person digital assistant 124 communicates with a data card 126 and a local area network 128. In this arrangement the PDA 124 transmits PJM.

When the data card 126 is within 0.2 m of the pda 124, the pda 124 imposes a low level phase modulation on a carrier signal 130, in accordance with a data signal containing financial credit card information for the data card 126 so as to create a modulated signal 132. The data card 126 then receives the modulated signal 132 from the pda 124 which derives the financial credit card information by demodulating the modulated signal 132.

During processing the data card 126 produces a first signal 134 being a local oscillator signal 136 from a local oscillator. The data card 126 then demodulates the modulated signal 132 using the local oscillator signal 136 to obtain an indicative data signal containing the financial credit card information. In operation the data card 126 amplifies an antenna signal, and then provides a portion of the amplified signal to a phase locked loop to filter off sidebands and create a first signal. The first signal being used to demodulated the amplified signal and recover the data signal as is discussed in the applicant specification, incorporated herein by reference. Alternatively, a portion of the amplified signal may be passed through a delay means to create a second signal with the second signal being used to demodulated the amplified signal and recover the data signal.

The data card 126 being without a power source must communicate to the pda 124 in a passive communication mode. The data card 126 transmits to the PDA 124 by modulating the carrier field provided by the PDA 124. Typically this modulation is by impedance loading and occurs using a modulated sub-carrier derived by dividing the carrier field. A selection of sub-carrier frequencies can be used by selecting different division ratios. Since the PDA 124 is generating the carrier signal the PDA 124 can use synchronous detection methods to detect and demodulate the modulate sub-carrier signals. The sub-carrier frequencies can be modulated with data rates as high as the low level phase modulation method described but have the limitation that they require an externally supplied powering field.

In a similar manner a short range wireless communication method according to an embodiment of the invention uses a phase modulation to enable a peer to peer area network 144 in which that the pda 124 communicates with the local area network 128. Once the financial information has been transferred the pda 124 is able to set up a wireless communication connection 146 using a phase modulation method with the local area network 128 to form part thereof. The wireless communication connection 146 is setup over a range of 5 m and then extends by controlling the modulated signals to a range of up to 20 m so as to allow the operator of the pda 124 to walk outside with the pda 124.

With the arrangement the pda 124 includes a first antenna 138 and; oscillator means 140 for providing a carrier signal. Moreover, the pda includes modulation means 142 for imposing a low level phase modulation on a carrier signal in accordance with a data signal to create a modulated signal. The modulation means 142 provides the modulated signal to the first antenna 138 for transmission to the local area network 128. The carrier signal also provides a means for powering a wireless input device associated with the pda, the wireless input device being a light pen (not shown). This is considered advantageous.

In comparison SRP-NFC operates by magnetic field induction at speeds of: 106 kbit/s, 212 kbit/s or 424 kbit/s. Arrangements of the present invention are able to operate at speeds of 424 kbit/s, 848 kbit/s and 1696 kbit/s. Higher data rates are achievable by using multilevel phase modulation methods which provide higher data rates without extending the spectrum of the transmitted signal.

In another embodiment the pda 124 comprises a server that uses the method according to the embodiment for file serving applications. The pda may accordingly be replaced by a personal computer forming a dedicated part of network 128 for printing operations, server operations, internet operations and so forth.

Similarly to SRP-NFC, bidirectional, passive and transponder communication methods may be provided for by embodiments of the present invention. In transponder mode the device gets its power from the corresponding device such that when brought into range the two devices can communicate despite one of the devices not having a power source.

Where ever a carrier is phase modulated the modulation sideband levels carry the data signal. The carrier signal carries no information and is typically suppressed to improve the efficiency of data transmission. For NFC different considerations apply. The carrier signal is required to provide the demodulation signal. Furthermore the carrier signal may be required to power the receiving device. These are quite different requirements from all data communication systems except RFID.

For analytical purposes a phase modulation may be regarded as a modulated quadrature component of the carrier that is added back to the carrier. For low level phase modulation this quadrature component is smaller than the carrier by a factor of at least 10.

It will be understood that phase modulation can be created by many methods including the method of adding a phase reverse keyed (PRK) quadrature component of the carrier back to the carrier. Alternatively simple phase delay circuits where a carrier signal is phase delayed, the phase delay being modulated by a data signal, will also generate perfectly acceptable phase modulated signals. For the simple delay modulation method the resultant phase modulated signal can still be partitioned for analytical purposes into a carrier signal and a PRK modulated quadrature component. The system is in no way limited by the method used for generating the low level phase modulated signal and any reference to carrier and a PRK modulated component is done for analytical convenience and clarity, even though the phase modulation might have been produced by a completely different method.

In this particular example the modulated signals appears as a phase jitter where the phase deviation are provided by the equation:THETA=arctan (2×Mag(PRK)/Mag(Fc)), where Fc is the carrier signal and PRK is the quadrature component.

The level of the modulation sidebands must be low enough to allow operation without restriction from government regulations. The maximum allowable sideband level is set by the International Telecommunications Union (ITU) and is −33 dBc. A sideband level of −33 dBc corresponds to a phase modulation level of 2 degrees. This represents a very small phase modulation as typical data communication systems will use 180 degrees or maybe 90 degrees. A sideband level of −24 dBc would be regarded as very small since only 1% of the transmitted power is in the sideband modulation while 99% of the transmitted power is in the carrier. A level of −24 dBc corresponds to a phase modulation level of 5.7 degrees.

Clearly where the carrier is used to power another device low level phase modulation is advantageous as essentially all the power (>99%) is available to power the receiving device. The data rate can be exceptionally high as the carrier signal is always present which allows for synchronous detection methods to be used for phase demodulation. These methods have the advantage of excellent signal to noise sensitivity as will be explained below.

It is known that reliable data communication is possible at a signal to noise ratio of 20 dB or higher. The carrier synchronous phase noise integrated over the data bandwidth must therefore be less than −53 dBc for reliable data demodulation at 2 degrees phase modulation (−33−20=−53). For a data rate 424 kbit/s the effective noise bandwidth is 666 kHz. The noise from 666 kHz corresponds to a 58 dB reduction in sensitivity, that is −53−58=111 dBc. A typical low quality crystal controlled oscillator will have a phase noise better than −140 dBc which is 29 dB lower (lower by a factor of 28) than that required for reliable demodulation.

As explained in the specification incorporated herein by reference, a low level signal having a modulated quadrature component is provided, with the low level signal appearing as a tiny phase jitter in the excitation field. Methods of producing small modulated phase shifts can be provided, for example, by passing the signal through a phase shifter such as an RC or tuned circuit, or through a variable length delay line to give a quadrature signal.

Nevertheless in the arrangement, a small portion of the excitation signal is phase shifted 90 degrees to give a quadrature signal. This is then PRK modulated with the data signal and added back onto the original excitation signal before being transmitted to the transmitter. The resultant signal can be amplitude limited to remove any residual amplitude component and any tiny phase shifts in the excitation induce corresponding antenna voltage phase shifts that are unaltered by any circuit impedances or power regulation circuitry connected to the antennas of transmitters or the antennas of receivers that receive the modulated excitation signal.

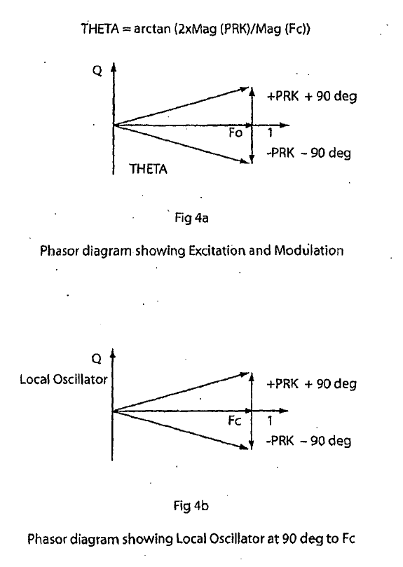

A phasor diagram of the excitation signal Fc and the modulated quadrature signal PRK is shown in the FIG. 4(a). The amplitude of the respective signals are given by their phasor lengths. The phase deviation THETA caused by the modulated quadrature signal is, for low level signals, extremely small and is given by (as detailed above):

THETA=arctan (2×Mag(PRK)/Mag(Fc))

For a 40 dB attenuated PRK signal THETA=1.2 degrees and for a 60 dB attenuated PRK signal THETA=0.12 degrees. Both of these are extremely small phase deviations of the excitation signal.

Phase quadrature modulation is recovered using a local oscillator (LO) signal, with a fixed phase with respect to the excitation signal, to down convert the modulated data to baseband in a mixer, multiplier or XOR gate. In the receiver the LO signal is derived from the modulated excitation signal. One preferred method of extracting a LO signal from the modulated excitation signal uses a Phase Locked Loop PLL in the receiver to generate the LO signal. The LO signal is generated by a low loop bandwidth PLL which locks to the original excitation signal's phase but is unable to track the high speed modulated phase shifts. The quadrature data signal is down converted and detected in a mixer or multiplier driven with the LO signal. Depending upon the type of phase detector used in the PLL, and the propagation delays through the circuit, the phase of the LO with respect to the excitation signal can be anywhere between 0° and 360°. If a conventional XOR phase detector is used in the PLL then the output of the PLL oscillator will be at nominally 90 degrees to the excitation signal and will be in phase with the data modulated phase quadrature signal. A 90° phase between the LO and the excitation signal is not necessary for the effective detection of quadrature phase modulation. An XOR mixer has a linear phase to voltage conversion characteristic from 0° to 180° and 180° to 360°. Hence it gives the same output amplitude irrespective of the phase angle except around 0° and 180° where there is a gain sign change.

The average output voltage DC level from a mixer is a function of the average phase difference between its inputs. It is more convenient for circuit operation for the average output to be around midspan and hence an LO with a phase angle of around 90° is more convenient. The phase of the LO signal can be simply adjusted using fixed phase delay elements. Hence a 0° or 180° phase detector can be used and a further 90° (roughly) of phase shift can be achieved with a fixed delay element.

Another method of recovering phase modulation is to use a delayed version of the modulated excitation signal itself for an LO signal. This method has the advantage of excellent phase noise and the delayed signal will have a fixed phase relation to the undelayed excitation signal except when there is a modulated phase change to the excitation signal. The delayed signal has a fixed phase with respect to the excitation signal, and can down convert the modulated data to base band in a mixer, multiplier or XOR gate. In the receiver the LO signal is derived from the modulated excitation signal. The quadrature data signal is down converted and detected in a mixer or multiplier driven with the LO signal. The demodulated signal will be the differential of the data signal. The data signal can be recovered by integration of the differential signal or by a simple window threshold detector that detects the positive and negative differential signal corresponding to positive and negative phase changes.

The average output voltage DC level from a mixer is a function of the average phase difference between its inputs. It is more convenient for circuit operation for the average output to be around midspan and hence an LO with a phase angle of around 90° with respect to the excitation signal is more convenient. The phase of the LO signal can be simply adjusted using fixed phase delay elements to achieve a 90° (roughly) of phase shift between the excitation signal and the LO signal at the mixer, multiplier or XOR inputs.

FIG. 4(b) shows a phasor diagram of the modulated excitation signal and a quadrature local oscillator signal in the receiver used to demodulate the data signal. The local oscillator signals phase is at 90 degrees with respect to the excitation signal's phase.

For phase modulation the data bandwidth is no broader than the original double sided data bandwidth. When attenuated the level of the modulated data spectrum is extremely low with respect to the excitation signal amplitude making conformance to regulatory emission limits significantly easier than with the prior art.

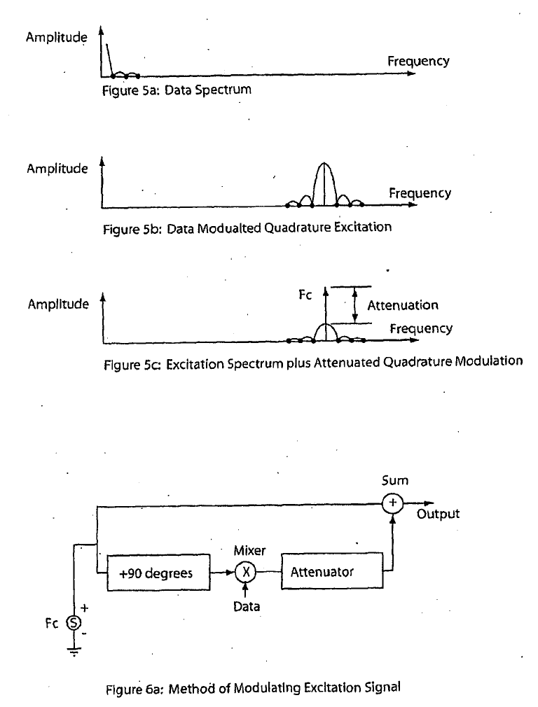

FIGS. 5(a) and 5(c) are representative frequency spectra that explain the operation of the invention. More particularly, FIG. 5(a) is a typical data spectrum. For data at 100 kbps the first zero of the frequency spectrum occurs at 100 kHz. FIG. 5(b) is a representative frequency spectrum of the data when modulated onto a quadrature version of the excitation signal. The spectrum for this type of modulation is the same as the double sided spectrum of the original data spectrum. In the invention the modulated quadrature signal is attenuated and added to the original excitation signal. FIG. 5(c) shows the spectrum of the excitation signal Fc plus the attenuated modulated quadrature signal whose spectrum is shown in FIG. 5(b). The attenuation level is given by the difference between the amplitude of the excitation signal and the amplitude of the data sidebands. Attenuation levels of 60 dB are achievable with this system and consequently sidebands interference levels are so low that they are not significant for regulatory emission purposes.

Since the spectrum of the transmitted excitation signal is equal to the original double sided data spectrum, narrow band high Q antennae can be used to respectively transmit and receive the modulated excitation signal. Consequently, the antennae will operate with high efficiency and the antennae likewise transmit and receive energy with high efficiency. In other embodiments use is made of low Q antennae.

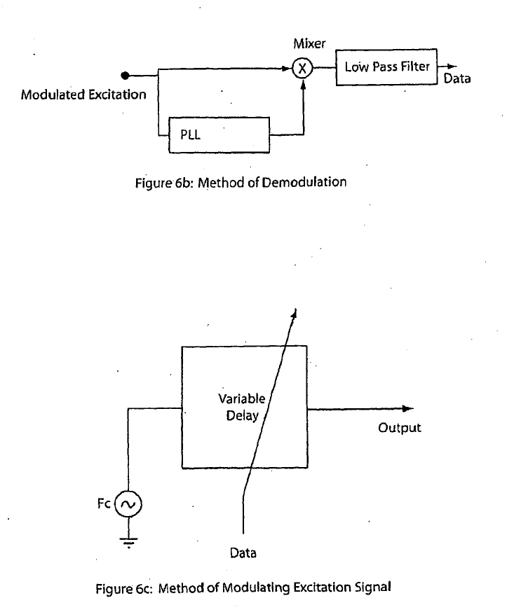

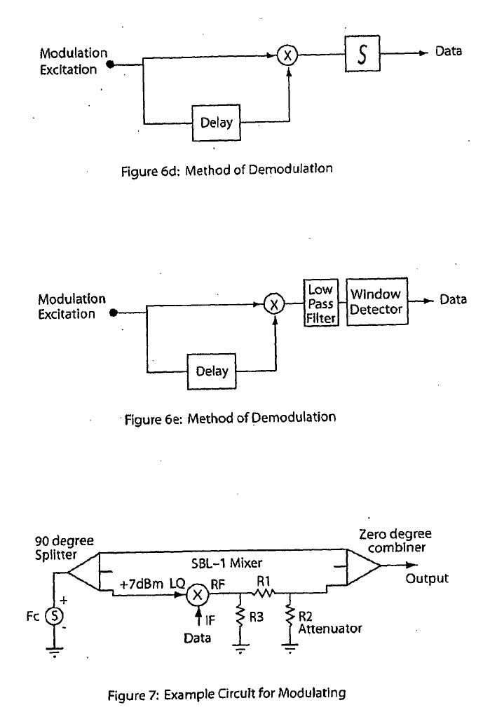

FIGS. 6(a) and 6(b) show methods of modulating and demodulating according to this invention. Turning first to FIG. 6(a), the portion of the main excitation signal is phase shifted 90 degrees to produce a quadrature signal. The quadrature signal is then modulated with data. The preferred form of modulation is phase reverse keying PRK. The PRK modulated quadrature signal is attenuated and then added back to the main excitation signal. Although shown in a particular order the sequence phase shift, modulation and attenuation are done in other orders in alternative embodiments. This method of modulation produces low level data side bands on the excitation signal where the sidebands are in phase quadrature to the excitation signal. The data signal appears as a low amplitude phase jitter on the excitation signal. In some embodiments the signal is further amplitude limited to remove any residual amplitude component.

FIG. 6(b) illustrates a method for demodulating the data modulated on to the excitation signal. A LO signal is generated by a low loop bandwidth phase lock loop PLL. The PLL locks on to the excitation signals phase and is unable to follow the high speed phase jitter caused by the data modulation. For the standard PLL phase detector the PLL oscillator will lock at a fixed phase with respect to the excitation signal's phase. This oscillator signal is then used as a LO to demodulate the quadrature sideband data signal in the multiplier. A low pass filter LPF filters out high frequency mixer products and passes the demodulated data signal.

FIGS. 6(c), 6(d) and 6(e) show further methods of modulating and demodulating according to this invention. Turning first to FIG. 6(c), the main excitation signal is phase shifted by a few degrees to produce the phase modulated signal. The phase shift being controlled by the data. This method of modulation produces low level data side bands on the excitation signal where the sidebands are in phase quadrature to the excitation signal. The data signal appears as a low amplitude phase jitter on the excitation signal.

FIG. 6(d) illustrates a method for demodulating the data modulated on to the excitation signal. A LO signal is generated by a fixed delay applied to the excitation signal. The phase between the excitation signal and the LO remains fixed except when there is a phase change caused by the data modulation. The LO is used to demodulate the quadrature sideband data signal in the multiplier. The LO signal demodulates the excitation signal and outputs the differential of the data signal. An integrator recovers the data signal.

FIG. 6(e) illustrates a method for demodulating the data modulated on to the excitation signal. A LO signal is generated by a fixed delay applied to the excitation signal. The phase between the excitation signal and the LO remains fixed except when there is a phase change caused by the data modulation. The LO signal demodulates the excitation signal and outputs the differential of the data signal. A low pass filter LPF filters out high frequency mixer products and passes the demodulated data signal to a window detector which detects the positive and negative pulses corresponding to positive and negative going phase modulations.

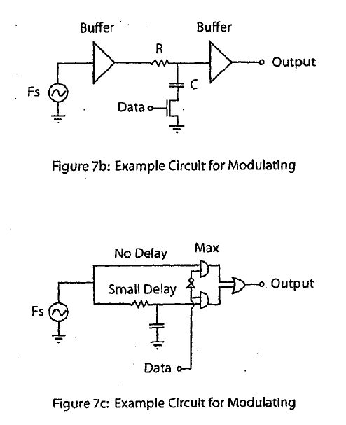

FIG. 7(a) shows an example circuit for encoding the data signal for transmission. An excitation reference source Fc is split through a 90 degree splitter. One output from the splitter is fed to the LO port of a mixer. Data is fed to the mixer's IF port and causes PRK modulation of the LO port's signal. The output of the mixer at the RF port is a PRK modulated quadrature signal. This is attenuated and added back onto the reference by a zero degree combiner ready for transmission.

FIG. 7(b) shows another example circuit for encoding the data signal for transmission. An excitation reference source Fc is passed through an RC circuit which delays the signal by a small amount. Typically a few nanoseconds for a 13.56 MHz excitation signal. The delay is controlled by the RC time constant which is adjusted by the transistor switch. The transistor switch, being modulated by the data signal, serves to modulate a phase delay of a few nanoseconds on to the excitation signal. The phase delayed component of the signal corresponds to the PRK modulated quadrature signal.

FIG. 7(c) shows an example circuit for encoding the data signal for transmission. An excitation reference source Fc is divided into two equal signals. One of these signals is passed through an RC circuit which delays the signal by a small amount. Typically a few nanoseconds for a 13.56 MHz excitation signal. The delay is controlled by the RC time constant. A MUX circuit then selects between the delayed and the undelayed excitation signals where the MUX selection is controlled by the data signal. The output of the MUX is a low level phase modulated signal where the phase delayed component of the signal corresponds to the PRK modulated quadrature signal.

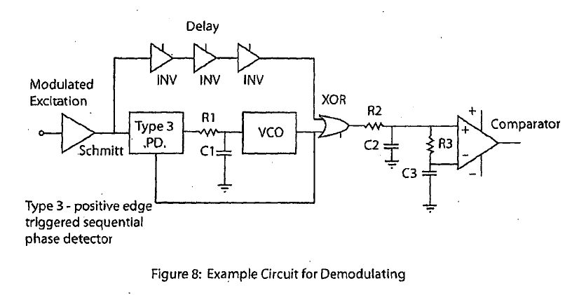

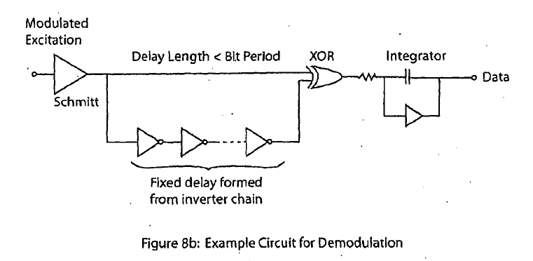

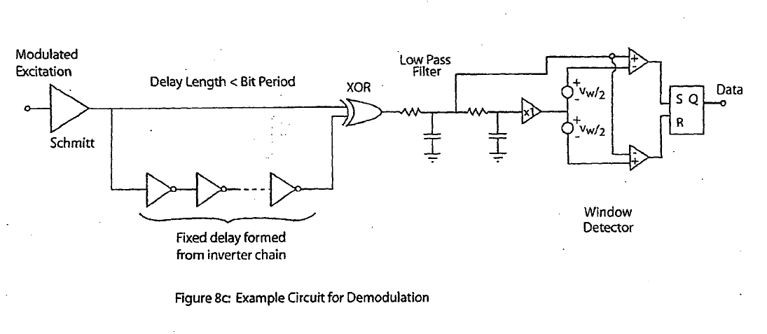

FIG. 8(a) shows an example circuit for decoding the phase modulated data signal. The antenna voltage is squared up by a Schmitt trigger, the output of which feeds a type 3 PLL. A type 3 phase detector is a positive edge triggered sequence phase detector which will drive the PLL oscillator to lock at 180° with respect to the input phase. With a low loop bandwidth the PLL is able to easily filter off the sidebands on the input signal. The output of the Schmitt is passed through a chain of invertors designed to add a fixed delay to the input signal. The delay is approximately chosen so that the phase of the output from the delay chain is not 0° or 180° with respect to the LO. A preferred phase value is 900 for circuit convenience. The output of the VCO acts as the LO to demodulate the Phase Jitter Modulated data. The data is demodulated in an exclusive OR gate, the output of which is low pass filtered and detected with a floating comparator.

FIGS. 8(b) and 8(c) show further example circuits for demodulating the phase modulated data signal. Both circuits show the antenna voltage being squared up by a Schmitt trigger, the output of which feeds an XOR phase detector directly and through a fixed delay. The delay is approximately chosen so that the phase of the output from the delay chain is not 0° or 180° with respect to the non-delayed signal at the XOR inputs. A preferred phase value is 900 for circuit convenience. In FIG. 8(b) the output of the XOR gate is integrated to recover the data signal by the op-amp integrator circuit. In FIG. 8(c) the output of the XOR gate is low pass filtered and detected using a window comparator.

It will be appreciated that a significant advantage of PJM is the relative ease with which it allows high attenuation of sidebands with respect to carrier amplitude. More importantly, this is achieved whilst maintaining relatively high data rates, which is not the case with prior art amplitude modulation schemes.

Although the invention has been described with references to specific embodiment(s), it will be appreciated by those skilled in the art that it may be embodied in many other forms.

For example, the sideband amplitude can be 10 dB, 20 dB, 40 dB or even 60 dB down with respect to the carrier.

A further embodiment is now disclosed having regard to application of the present invention to document management and/or office communications, in particular, but without limitation, the invention may be applied to a system and method of controlling the unauthorized reproduction of documents and cataloguing, searching, authenticating and retrieving of documents and/or articles, as well as a system and apparatus therefor. In one embodiment, the present invention has application to an apparatus and a system which, for example, photocopy, fax, scan, print and the like. This embodiment has application in all environments where documents may be found or stored, such as offices, warehouses, as well as where documents are placed such as desks, cabinets, safes, security vaults and other storage rooms circumstances and situations. It will be convenient to hereinafter describe the invention in relation to an office environment and office equipment, however it should be appreciated that the present invention is not limited to only that use.

The inventors have found that document management has several different applications. It may comprise cataloguing of information into a database for easy retrieval of information, or it may be digitization of all data so that everything can be placed into searchable form and made available electronically.

The inventors have come to the realisation that in some environments, the identification and/or location of the actual document itself is important and, moreover, that in some situations it would be advantageous to reproduce documents for subsequent use.

The inventors have discovered that the tracking of documents in and around offices, as well as the tracking of the time any document is held in any one location and the security of those documents is considered of major concern to business.

With this in mind, the inventors have identified several present and existing document management systems that have been adopted to manage the flow of documents in an office.

For example, colour coding can be used in association with the document. When a number of documents are placed in a filing cabinet, the colours of each document will form an easily recognisable pattern. Thus, if one document is placed out of its correct place, an interruption to that pattern can be readily observed. Sensitive documents can be marked with a particular colour to provide a visual identification. There are however a number of disadvantages associated with these systems, several of which relate to unauthorised copying.

The inventors also have discovered that there are some present and existing instances of the application to and the use of Radio Frequency Identification (RFID) Tags in relation to document management. Heretofore RFID tags have previously and predominantly been used in association with relatively larger items such as shipping pallets, airline baggage, storage boxes or crates, where separation between tagged articles is maintained by the need for singulation and sortation and hence coupling between tags does not produce spurious effects

Furthermore, the inventors have realised that in an office environment the tracking of various parameters, including the monitoring and recording of staff work and efficiency (such as hours billed) is important. Various systems exist that record time and costs associated with photocopying and other clerical duties. Other systems act somewhat as a diary, promoting ‘tasks’ for a person to do. However, these various systems are in effect stand alone systems. Although the data may be recorded onto a single or central database, there is little if any synergy or linkages between the various systems. For example, time recording alone does not take into account turn around time, the location of a file at a particular point in time, the person in possession of the file, nor the status of the file.

In a preferred embodiment, the RFID tags and related devices include those as disclosed in PCT/AU03/01072, Australian Provisional patent application number 2002950973, filed 22 Aug. 2002, Australian Provisional patent application number 2004901683, filed 29 Mar. 2004, Australian Provisional patent application number 2004903107, filed 9 Jun. 2004, Australian Provisional patent application number 2004903694, filed 7 Jul. 2004 and Australian Provisional patent application number 2005906824, filed 6 Dec. 2005 the disclosure of each of which is explicitly incorporated herein by reference. The tags use ‘stackable technology’, such as an un-tuned antenna design (in one embodiment only) with antenna current management which has been found to reduce interference effects, and thus has been found to be suitable in a document management system where documents are likely to be relatively closely stacked or held.

Preferred embodiments of the invention may also make use of methods and systems disclosed in PCT/AU98/01077, PCT/AU99/00059, PCT/AU01/00203, PCT/AU2003/001072 (noted above), PCT/AU2005/000764, Australian provisional patent application 2005904985 filed on 12 Sep. 2005, Australian provisional patent application 2005904988 filed on 12 Sep. 2005, Australian provisional patent application 2005904990 filed on 12 Sep. 2005, and Australian provisional patent application 2005905027 filed on 12 Sep. 2005.

In relation to this example application, the term ‘document’ or ‘article’ includes any indicia supporting medium, such as, for example, reference to paper, linen, plastic and other such objects, such as magazines, journals, medical files, X Ray films, contract documents, legal files, passports, letters, a number of pages, single pages, folios, complete files, file folders, one or more articles or things such as pharmaceuticals, drugs, blood or tissue samples certificates, books, boxes, office stationery, office supplies, office equipment and various other articles that may require identification and/or location, as well as electronic records associated with such ‘document’. Reference to a ‘document’ or ‘article’ also refers to any number of ‘documents’. Furthermore, reference to a document or ‘article’ may include reference to one ‘document’ or ‘article’ ‘residing in or being associated with another ‘document’ or ‘article’.

In relation to this example application, reference to an ‘interrogator’ or ‘interrogated’ includes reference to a read only or read and write device or act that may power a tag, communicate with a tag, receive information from a tag, read a tag, transmit information to a tag and/or signal to and/or from a tag. This includes for example an RFID enabled in and out tray or central registry document repository adapted to communicate with tags stored or moved therein.

In relation to this example application, reference to a ‘tag’ includes reference to one or more RFID tags and/or reference to a tag(s) as disclosed in the incorporated disclosures noted above. In one specific form of the invention, a tag is defined as a label or adhesive note or other method of affixing identity to an article or thing in any form, such as a device comprising an Application Specific Integrated Circuit (ASIC) “chip” attached to an antenna or having an antenna attached to it, or where an antenna forms part of the chip assembly itself and where the chip and the antenna structure, including optionally a capacitor or capacitors and which device functions as an inductively powered passive transponder, or an electro-magnetically power passive transponder, or a capactively powered passive transponder, or a battery powered electronic transponder or is a transponder powered by some other means.

This application of the invention may be implemented via any number of devices such as ‘interrogator’, ‘transponder’ and/or ‘management system’ and reference to such devices is a reference to devices of any kind. Examples of specific arrangements are provided in the documents incorporated into this disclosure, by way of reference, and other examples would be apparent to the skilled addressee.

This application of the invention is adapted to operate with tags that are relatively closely stacked such as between 0 mm and 50 mm, for example only 1 mm between tags, which overlap and where the tags can also be actually touching. The invention is also adapted to operate with tags that are spaced much wider apart such as 5 cm or more. Furthermore, the invention is adapted to operate with tags and interrogators which can also have varying orientations. That, is the invention in certain interrogator implementations is relatively insensitive to the orientation of the tag or how the tag is presented to the interrogator.

In essence, this application of the invention comes about due to the realisation that RFID technology can be applied to reproduction methods, systems and/or apparatus in order to control, record and/or manage the reproduction of articles and/or indicia. In accordance with the invention, interrogator and tags can be associated with photocopier, fax, scanner and printer apparatus and systems in a manner which will enable, record and/or disable the apparatus and/or system function depending on criteria determined from the association of tags and/or interrogators. For example, the interrogator may be proximate to the lid, feeder and/or platen cover of the apparatus and the tag associated with the article to be reproduced.

Preferably, the embodiment relates to RF & HF technology, but may be implemented using similar equipment at other frequencies if required.

The embodiment has been found to result in a number of advantages, such as:
Inhibit apparatus from reproducing any or selected articles Record and/or catalogue the reproduction of any or selected articles
The reproduction and/or enablement of reproduction may be selective i.e. certain articles may be reproduced, while other articles may not be reproduced.
Provide an indication of any attempt at the unauthorised reproduction of documents,
Link the reproduction of documents to an identifier associated with a person operating the reproduction apparatus. This may be used for control, security and/or costing purposes.

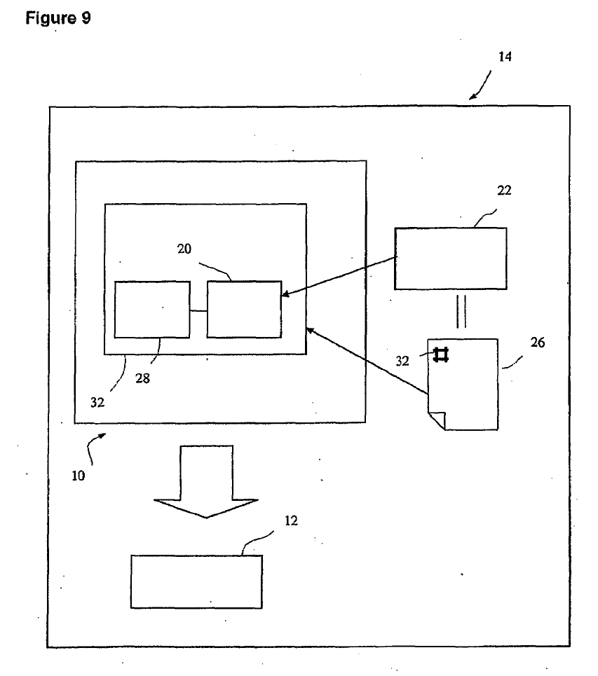

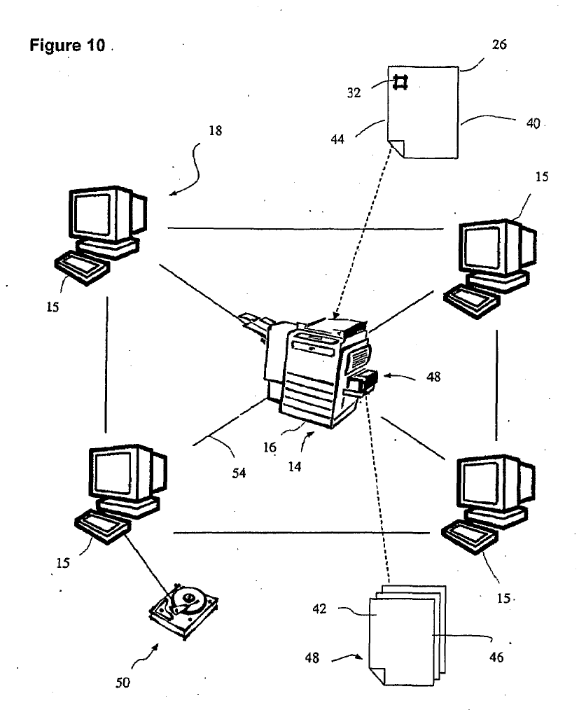

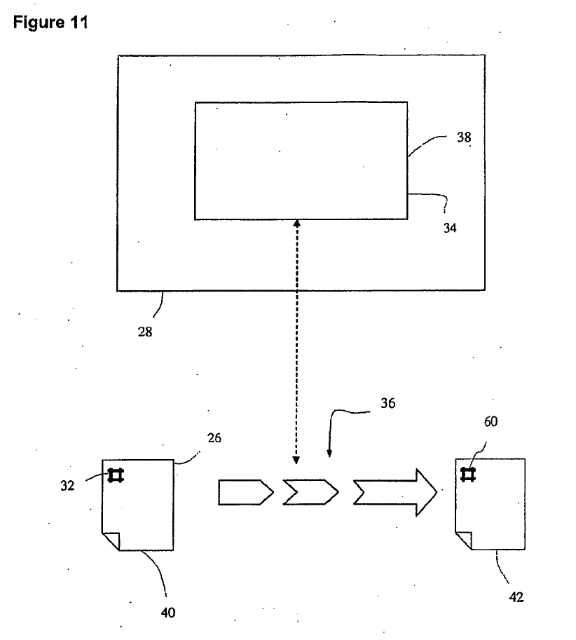

Referring to the FIG. 9 there is shown a device 10 according to a first preferred embodiment of the invention. The device 10 is adapted to determine reproduction criteria 12 and is used within a document management apparatus 14. FIG. 10 shows that the document management apparatus 14 comprises a photocopier 16 within a computer network 18 including four computers 15.

The device 10 comprises a receiver 20 for receiving information 22 corresponding to a radio frequency device 24 that is associated with a reproducible article 26 and logic means 28 for determining reproduction criteria 12 based on the information 22.

As shown in FIG. 9 an interrogator 32 is adapted, in accordance with the embodiment, to communicate with the radio frequency device 24 associated with the reproducible article 26.

Referring to FIG. 11, the logic means 28 includes control means 34 that is configured to enable a reproduction process 36 based on the reproduction criteria 12. In this manner the interrogator 32 in combination with the other components of the device 10 adapts the document management apparatus 14 that is, the photocopier 16, to selectively allow certain reproducible articles (documents) to be photocopied.

In the photocopier 16 the control means 34 functions as an activation means 38 that enables operation of the photocopier 16 based on the reproduction criteria 12. The control means 34 in fact enables the reproduction process 36 such that the reproduction process 36 operates between a first paper form 40 and a second paper form 42.

Referring to FIG. 10 the first paper form 40 comprises the reproducible article 26 provided as a sheet of paper 44 with the radio frequency device 24. The second paper form 42 comprises a second sheet of paper 46 that is finally produced from the first sheet in a stack of paper 48 within the photocopier 16.

With this arrangement the sheet of paper 44 contains the radio frequency device 24 by the radio frequency device 24 being adhered thereto. Other arrangements are of course possible.

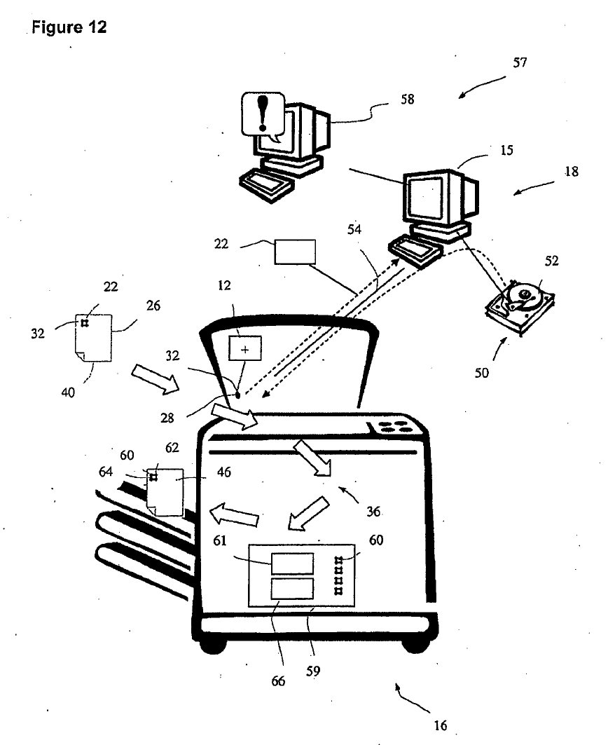

Referring to FIG. 12 the interrogator 32 is located in the platen cover of the photocopier 16 such that when the sheet of paper 44 having the radio frequency device 24 adhered thereto is located on the glass platen of the photocopier 16, the interrogator 32 is proximate the radio frequency device 24. The disposition of the interrogator 32 is shown in FIG. 12 and is particularly advantageous.

With this arrangement the logic means 28 of the interrogator 32 is configured to determine the reproduction criteria 12 by performing a query of a policy database 50 containing a plurality of policy reproduction rules 52. In this embodiment the information 22 is sent to the receiver 20 which in turn results in the logic means 28 sending the information 22, in a first form, to the policy database 50 over a network connection 54 that connects the photocopier 16 to the computer network 18. A query using the first form of the information 22 operates to firstly return a security level associated with the reproducible article 26. The security level is predetermined according to the sensitivity of the article 26, i.e. the sensitivity of the information printed on the sheet of paper 44.

In this embodiment the rules 52 corresponding with both the location of the photocopier 16, the operator 56, which in this case is known through an identifier such as an identifier tag or a keypad activation system, and the information 22 queried. If predetermined rules, such as a rule or a set of rules, is satisfied then the reproduction criteria 12 returns a positive result. On the positive result the logic means 28 activates the reproduction process 36 such that the first sheet of paper 44 is photocopied to provide the second sheet of paper 46. Thus it will be apparent that logic means 28 selectively allows the first paper form to be photocopied based upon the reproduction criteria 12.

The photocopier 16 within the computer network 18 provides an advanced read/write RFID system operating at 13.56 MHz with specialised chips, tags, readers and operating software. Other RFID operating frequencies may also be used, such as, without limitation, 860 MHz to 960 MHz or 125 kHz to 134 kHz. Given that some documents require special handling due to security limitations and the system is able to provide the technology to ensure that the security provided is sufficiently secure and that appropriate warnings are given when a document is attempted to be reproduced.

In the system, hereinafter referred to as document management system 57, if the query of the policy database 50 returns no satisfied policy reproduction rule 52 then a warning tagging the operator 54 is sent to an alert system 58 within the network 18. Security scanners adjacent doorways ensure that the documents are not moved to a less secure area.

It is considered that embodiments of the invention will find application in particular in government departments and agencies. All documents are catalogued according to their sensitivity and the reproduction rules 52 built therefrom. The documents are tracked using scanners in common thoroughfares, desktop scanner configured as in or out trays, and all photocopiers, fax, printer, and scanners fitted with devices such as device 10. In this manner a mechanism is provided whereby the location of information is sufficiently visible at all times.

In a government department comprising various ministers and department heads official documents all enter the department at a single point where they are security checked. The documents are all catalogued and radio frequency devices adhered thereto according to their sensitivity in view of the policy rules 52. After this the documents are sent to the appropriate clerical staff. The staff then control the documents, ensuring that they are sent to the appropriate people and that they come back into the archives after the meetings and so on. Although photocopiers and scanners are provided they are fitted with devices such as device 10 to provide appropriate security.

Furthermore the device 10 includes means 59 for applying one radio frequency device 60 from a plurality of radio frequency devices onto the second sheet of paper 46 and means 61 for initialising the radio frequency device placed on the second sheet 46 such that radio frequency device 60 contains information 64, the information 64 having an association with at least information 22 and possibly printer 16 and operator 54. In this advantageous arrangement the information 64 is also recorded in the policy database 50.

Although not explicitly shown, the radio frequency device 60, or any of the RFID devices disclosed herein, may include one or more tamper evident element 62 which when adhered to, or otherwise associated with, the second sheet of paper 46 provides a tamper evident connection therewith. An example of a tamper evident element is disclosed in PCT patent application PCT/AU2006/001419, entitled ‘A Vessel Closure’ filed 29 Sep. 2006, the subject matter of which is wholly incorporated herein by reference. Thus should there be an attempt to remove the device 60 from the paper 46, the device will be rendered inoperative, and thus copying of the paper 46 will not be enabled by logic 28 as no communication will be received from the device 60 to the logic means 28.

This tamper evident feature may be applied to any device disclosed herein rendering the device inoperative should an attempt be made to remove or otherwise copy the device in a fraudulent or non-approved manner. The tamper evident feature may be manifested by a weakening in the device, a component of the device (such as the ASIC) and/or the antenna. For example, if the device was to be removed, an attempt to remove the device would break or tear the antenna in one or more places, or may break or destroy the ASIC or another component of the device. Reference is also made to co-pending Australian Provisional patent application number 2005906824, filed 6 Dec. 2005 herein incorporated by reference.

Furthermore, the RFID device may be ‘polled’ periodically by the interrogator or another suitable system to reassert it's authenticity, and if the polling is not completed correctly, the RFID device maybe considered to have been tampered with or no longer operative and in consequence be ‘deregistered’ from any authenticating system thus rendering the device inoperative. Notifications, messages and/or alarms can be sent to appropriate people and/or systems to alert that the device has been ‘deregistered’. This will have ramifications should copying of the article to which the device is associated be attempted. The copying process will fail if the device has been tampered with, rendered inoperative and/or have been deregistered.

As an added feature the device 10 includes an audit means 66 that is adapted to generate audit information for printing with photocopier 16. The report generated details which documents were copied by whom on which dates. Other details may be provided.

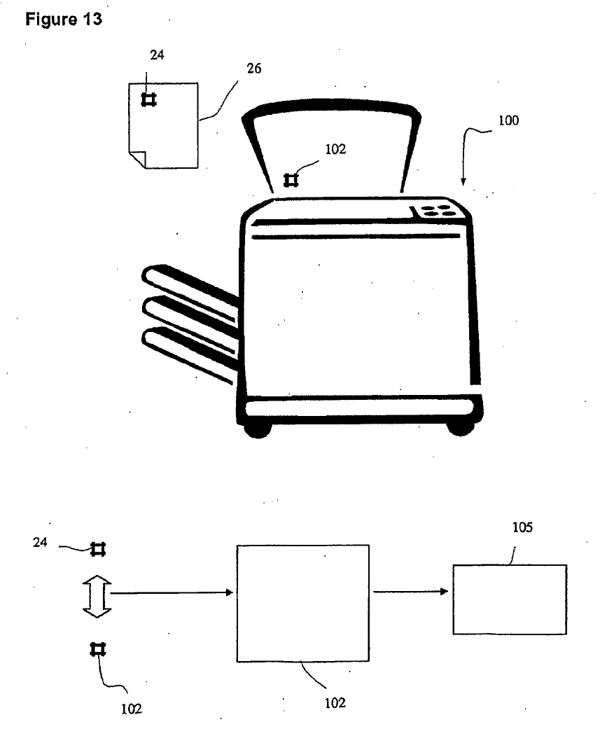

A variation of the first embodiment, shown in FIG. 13, comprises a reproduction apparatus 100 such as a photocopier, fax, scanner, or printer. In the case of a photocopier, the interrogator or radio frequency device 102 is placed in the lid or platen cover of the device. The radio frequency device 102 operates with the radio frequency device 24 of the reproducible article 26. The radio frequency device 100 is located in the lid of the reproduction apparatus such that some time during a copy request action the two radio frequency devices 24, 102 will be brought into proximity of one another and will mutually couple. In this embodiment the radio frequency devices 24, 102 comprise coils.

In a further variation an interrogator 103 remote from the device 100 is configured to receive a signal indicative of mutual coupling between the two radio frequency devices 24, 102 during the copy request. Once the signal is received the interrogator 103 determines the reproduction criteria 12 and, if positive, sends a signal 105 corresponding to reproduction criteria to the device 100 allowing the photocopy request. In the absence of the a signal indicating that the radio frequency device 102 is in proximity of the radio frequency device 24 the interrogator 103 ensures that the device 100 is not operable.

In other arrangements the return of positive reproduction criteria 105 causes the device 100 to be enabled for a predetermined period of time or until the two radio frequency devices 24, 102 are separated and there is no mutual coupling.

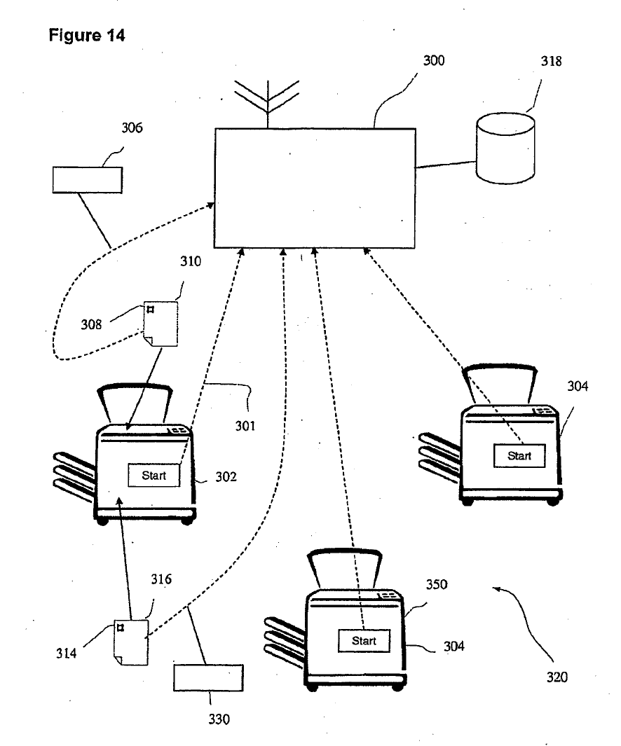

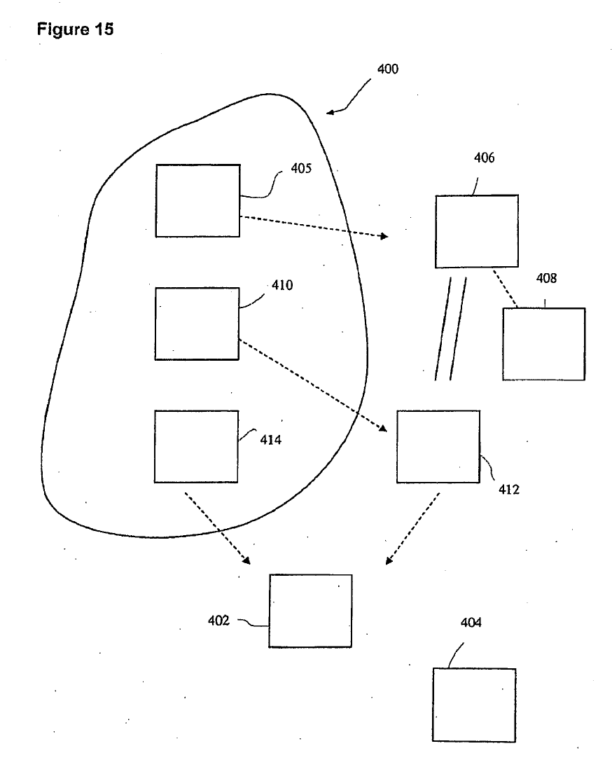

In a further embodiment shown in FIG. 14, an interrogator 300 is activated upon a photocopy request 301 being sent by a photocopier 302. The interrogator 300 is positioned remotely from photocopier 302 so as to be able to be activated by any one of a plurality of photocopiers 304. Upon activation the interrogator 120 interrogates the vicinity of photocopier 302 to receive information 306 from a radio frequency device 308 adhered to an article 310 being photocopied. Furthermore the interrogator 300 interrogates the photocopier 302 to receive information 312 from a radio frequency device 314 on a second sheet of paper 316 onto which a representation of the article 310 will be copied. Subsequently the interrogator 300 updates a database 318 in network 320 to record an association therebetween

In another embodiment a printer 304 operates as a scanner 350 and a control means (not shown) within the scanner 350 the enables a reproduction process such that the process operates between a paper form and an electronic form. The sheet of paper to be scanned comprises the paper form and the electronic document or documents produced comprise the electronic form which is dispatched to a predetermined location in the computer network 320. In this embodiment the electronic form comprises a PDF document.

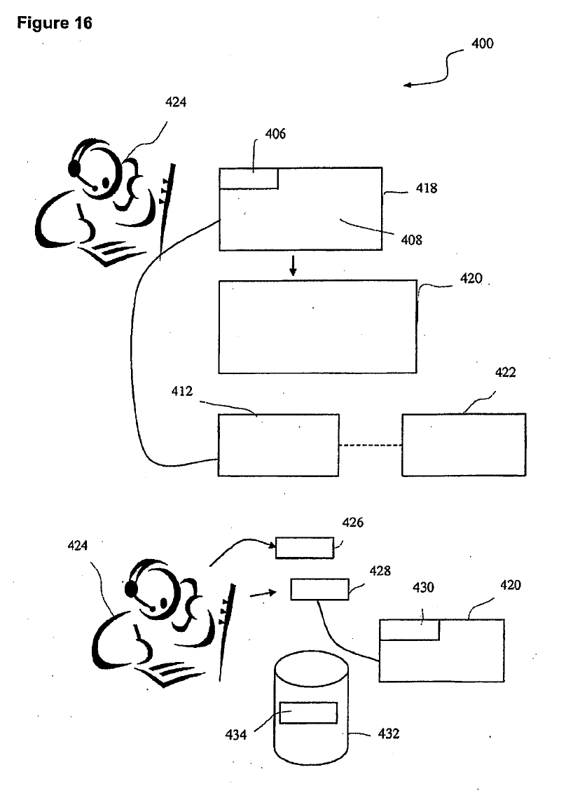

According to a further embodiment of the invention, represented by FIG. 15, there is provided a method 400 of determining reproduction criteria 402 for use in a document management apparatus 404. The method block 405 includes associating a radio frequency device 406 with a reproducible article 408. Subsequently block 410 of the method involves receiving information 412 corresponding to the radio frequency device 406 and block 414 involves determining reproduction criteria 402 based on the information 412.

The method 400 includes selectively activating and/or inhibiting a reproduction of process. In this respect the reproduction process is activated upon the reproduction criteria being satisfied. For example, the reproduction criteria may define:
what may or may not be reproduced,
what reproduction needs to authorised (with reference to a policy database, for example),
which reproduction apparatus and/or systems may be enabled for the reproduction,
what information is obtained from or written to the article in the reproduction process
what information is recorded, such as the number of copies, who made the copies (via password authority), what apparatus etc
whether any further criteria are required in the reproduction process,
who is authorised to carry out a reproduction process.

More particularly, with reference to FIG. 16, the method 400 includes placing the reproducible article 408 in the form of a piece of paper 418 having the radio frequency device 406 adhered thereto, on a scanning device 420. The radio frequency device 406 is pre-programmed to store information 412 such that the information 412 indicates that the information printed on the piece of paper 418 has a security identifier 422.

After the piece of paper 418 is placed on the scanning device 420 an operator 424 enters an identification code 426 into an electronic device 428 connected to the scanner 420. In this embodiment the electronic device 428 comprises a keypad however the identification code 426 may be received using a radio frequency identification system. The operator 424 then presses a button on the scanner 420 to initiate a scan request. The scan request is received by the scanner 420 and activates an interrogator 412 in the lid of the scanner 420. The interrogator 412 interrogates the piece of paper 418 such that the radio frequency device 406 returns the security identifier 422 to the interrogator. The interrogator 412 then queries querying a policy database 432 containing a plurality of policy reproduction rules 434 to determine whether the reproduction criteria returns a positive result. If the result is positive the interrogator enables a reproduction process whereby the scanner provides the electronic form of the piece of paper in a compressed and secure document that is watermarked and password protected with information associated with the security identifier 422. The association is recorded in an association database. Alternatively, the interrogator may enable a reproduction process to a paper form.

Thus it will be appreciated that the present inventors have realised that knowledge and information management is considered very important to any organisation and that security is often of great importance. Rather than having to avoid the use of scanner, photocopies and other reproductive equipment knowledge and information learned in a project should carry forward to subsequent projects. With reproduction and tracking of documents this can be achieved. Examples include government, medical and legal case files and documents, information, records, protocols and practices created earlier can be reused if proper management is in place.

Properly managed documents provide cost savings in terms of reduced effort to locate a document, redo or rewrite a document and also prevent lost documents. Lost documents mean loss of knowledge stored in the document.

The present inventors have come to the realisation that that Radio Frequency Identification (RFID) is a suitable technology to use in implementing document tracking, not least of which for the reasons outlined in the advantages noted above.

An example of apparatus and/or methods that may be used in association with the present invention are given in the disclosures of PCT/AU98/01077 entitled “A transmitter and a method for transmitting data”, PCT/AU2005/000764 entitled “Method, System and Apparatus for document management”, PCT/AU03/01072 entitled “An identification device and an identification system” and AU2005904985 entitled “A method and apparatus to transmit data”. These documents are hereby explicitly incorporated by reference.

Although the present invention may be implement via devices of any kind, preferred embodiments of the invention may make use of methods and systems disclosed in PCT/AU98/01077, PCT/AU99/00059, PCT/AU01/00203, PCT/AU2003/001072 (noted above), PCT/AU2005/000764, Australian provisional patent application 2005904985 filed on 12 Sep. 2005, Australian provisional patent application 2005904988 filed on 12 Sep. 2005, Australian provisional patent application 2005904990 filed on 12 Sep. 2005, and Australian provisional patent application 2005905027 filed on 12 Sep. 2005. These documents are also hereby explicitly incorporated by reference.

Among other things it will accordingly be appreciated that the embodiments embrace following the trail of a mail through an office where one or more tags are physically applied or associated with the mail. The tags may comprise chips, antenna, coils and other elements on a flexible substrate and information regarding the document, may be input into the document tray reader, interrogator or other tracking device which may be adhesively or otherwise applied or associated with the document. The tags may be applied to the rear, front and or side of the document. The information may comprise a unique code or information. However, the identification information may be of any suitable kind, again in accordance with the specific use to which the preset invention is put. The code may identify:
Source of the document author and time/date,
Security classification,
Who is authorised to see and/or copy the document,
Action officer,
What action is required,
Who is to do what by when,
time and date of receipt, deadline or due dates,
type of document, whether the document is a fax, letter, photocopy or email copy, invoice,
to whom the document is addressed,
copyright and/or royalty information,
what references are noted on the document,
other information thought to be of relevance in accordance with management practice in the particular office where the present invention is used. The substrate of the tag may also include some indicia (of any kind) for visual recognition of the tag.

Auditing of the trail of the document including copies thereof may be communicated by way of with a person's diary, email or tasks list, that the document has been placed on their desk. A time record can then be generated.

A record or audit trail of reproductions made may be also used to attribute copyright royalty payments if and where appropriate.

Furthermore in embodiments especially those involving relatively close stacking of tags, the tags should be constructed with the following factors in mind.
Substantially reducing or eliminating resonant currents by not tuning the antenna coil (preferably at manufacture) so that it is not a resonant coil,
Switching the tag between high and low power states or active and in-active states wherein the current drawn from the antenna is as small as possible in the low power (inactive) state.
Each tag may be switched deliberately and/or randomly, so that there is a relatively low probably of having two tags ‘active’ and adjacent to each other at any one time,
where two tags are interrogated simultaneously and/or have interfered with each other, ignoring that tag interrogation,
Minimising functions performed by the tags when inactive,
Utilising relatively low power circuits,
Using on-chip memory devices which may store temporary data during an ‘active’ or powered cycle such that the stored data may also be held during the ‘un powered’ or in-active cycle, and
Making the impedance ‘seen’ by the antenna coil as large as possible, particularly in the ‘in-active’ state of the tag.

Communication may be via a LAN or other communication means, such as wireless communication means and various sensing systems may be constructed. The relevant policy databases my include tables for access and/or recording of any information associated with documents, time tracking, personnel, addresses, and tables for recording or access to billing or other accounting information associated with documents. Additionally the relevant policy databases my include tables for recording billing information associated with those documents.

It can be seen having regard to the disclosure herein that the present invention has a wide variety of applications, such as, without limitation:
embodiments may be provided for digital image processing where digital cameras are talking to professional printers;
for video conferencing applications with PDAs;
directed advertising based on data card movement;
peer to peer personal and/or local networks including, without limitation such wireless communications devices as digital pens, headsets, laptops, desktop computers, printers, scanners, wireless keyboards, wireless mouse, various other computer accessories and associated devices, hearing aids, pace makers, heart monitors and so forth. Additional security measures such as PIN codes may also be provided for;
Mobile Phone for payments, access applications or information retrieval, such as for example, without limitation, from information sources like Advertisement Posters, PJM tagged objects;
Payment Terminals, such as without limitation, to conduct payments using a token or mobile phone/PDA;
Real time locating systems using PJM as the communication method;
Remote controls transmitting/receiving remote control information to industrial machines, audio/video, intelligent houses;
Data loggers which retrieve data via the PJM communication method from any kind of information source;
Push Services for information or advertisement (the door/poster, device pushes information onto your PDA/Phone);
Fast access applications (Fast moving transportation carriers which will activate authorized access to buildings/doors/gates);
Road information systems to transmit local road data to cars passing this segment/information posting; and
any NFC communication application, method and/or device.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. The described embodiments are to be considered in all respects as illustrative only and not restrictive.

Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

It should be noted that where the terms “server”, “secure server” or similar terms are used herein, a communication device is described that may be used in a communication system, unless the context otherwise requires, and should not be construed to limit the present invention to any particular communication device type. Thus, a communication device may include, without limitation, a bridge, router, bridge-router (router), switch, node, or other communication device, which may or may not be secure.

It should also be noted that where a flowchart is used herein to demonstrate various aspects of the invention, it should not be construed to limit the present invention to any particular logic flow or logic implementation. The described logic may be partitioned into different logic blocks (e.g., programs, modules, functions, or subroutines) without changing the overall results or otherwise departing from the true scope of the invention. Often, logic elements may be added, modified, omitted, performed in a different order, or implemented using different logic constructs (e.g., logic gates, looping primitives, conditional logic, and other logic constructs) without changing the overall results or otherwise departing from the true scope of the invention.

Various embodiments of the invention may be embodied in many different forms, including computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof. In an exemplary embodiment of the present invention, predominantly all of the communication between users and the server is implemented as a set of computer program instructions that is converted into a computer executable form, stored as such in a computer readable medium, and executed by a microprocessor under the control of an operating system.

Computer program logic implementing all or part of the functionality where described herein may be embodied in various forms, including a source code form, a computer executable form, and various intermediate forms (e.g., forms generated by an assembler, compiler, linker, or locator). Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), a PC card (e.g., PCMCIA card), or other memory device. The computer program may be fixed in any form in a signal that is transmittable to a computer using any of various communication technologies, including, but in no way limited to, analog technologies, digital technologies, optical technologies, wireless technologies (e.g., Bluetooth), networking technologies, and inter-networking technologies. The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality where described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM or DVD-ROM), or other memory device. The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies. The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

“Comprises/comprising” when used in this specification is taken to specify the presence of stated features, integers, steps or components but does not preclude the presence or addition of one or more other features, integers, steps, components or groups thereof.” Thus, unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”.

1. A short range wireless communications method, the method comprising:
providing a carrier signal;
imposing a phase modulation on the carrier signal to create a modulated signal;
providing the modulated signal to a wireless communications device;
wherein the phase modulation on the carrier signal is in accordance with a phase deviation where the phase deviation is in accordance with a data signal.

2. A method of short range wireless communications, the method including:
providing a carrier signal;
imposing a phase modulation on the carrier signal, in accordance with a data signal containing data, to create a modulated signal; and
transmitting the modulated signal from a first wireless communications device to a second wireless communications device, the second wireless communications device having means for determining the data contained within the data signal, from the modulated signal.

3. A method of near field communications, the method including:
providing a carrier signal;
imposing a low level phase modulation on the carrier signal, in accordance with a data signal containing data, to create a modulated signal;
transmitting the modulated signal from a first wireless communications device; and
controlling the modulated signal transmitted in order that the data contained within the data signal is not able to be extracted, due to noise, by a second wireless communications device when outside a 0.2 m radius.

4. A method of demodulating a modulated signal received by a wireless communications device and deriving therefrom a data signal, the method comprising the steps of:
receiving the modulated signal;
producing a first signal being a local oscillator signal;
demodulating the modulated signal using the local oscillator signal to obtain an indicative data signal.

5. A method of demodulating a modulated signal received by a wireless communications device and deriving therefrom a data signal, the method comprising the steps of:
receiving the modulated signal and inducing into an antenna of the device, an antenna voltage signal,
amplifying the antenna signal,
providing a portion of the amplified signal to a phase locked loop to filter off sidebands and create a first signal,
demodulating the modulated signal using the first signal to obtain an indicative data signal; and
filtering the demodulated signal to provide the data signal.

6. A method of demodulating a modulated signal received by a wireless communications device and deriving therefrom a data signal, the method comprising the steps of:
receiving the modulated signal and inducing into an antenna of the device, an antenna voltage signal,
amplifying the antenna signal,
passing another portion of the amplified signal through a delay means and creating a first signal,
demodulating the modulated signal using the first signal to obtain an indicative data signal, and
filtering the demodulated signal to provide the data signal.

7. A short range wireless communications method between a plurality of wireless communications devices in an area network, the method comprising:
providing a carrier signal;
imposing a phase modulation on the carrier signal to create a modulated signal;
providing the modulated signal to a first one of the wireless communications devices; the phase modulation on the carrier signal being in accordance with a phase deviation where the phase deviation is in accordance with a data signal; and;
thereafter transmitting the modulated signal from the first wireless communications device and receiving the signal at a second one of the wireless communications devices.

8. A method as claimed in any one of claims 1 to 7, wherein the modulated signal appears as a phase jitter.

9. A method as claimed in any one of claims 1 to 7, wherein the modulation is low level phase modulation.

10. A method as claimed in claim 1, wherein the wireless communications device is a personal area network device.

11. A method as claimed in claim 1, wherein the wireless communications device is a local area network device

12. A method as claimed in claim 1, wherein the wireless communications device comprises a data card sized for being carried in a wallet.

13. A method as claimed in claim 1, wherein the method is a financial transaction communication method and the data signal contains information relating to a financial transaction.

14. A method as claimed in claim 1, wherein the method includes an authentication procedure involving a set of two-way communications between the wireless communications devices.

15. A method as claimed in claim 1, wherein the modulated signal has a quadrature component.

16. A method as claimed in claim 1 wherein the phase deviation is provided by the equation: THETA=arctan (2×Mag(PRK)/Mag(Fc)), where Fc is the carrier signal and PRK is the quadrature component.

17. A method as claimed in claim 16 wherein the quadrature component is derived from a portion of the carrier signal, that is phase shifted 90 degrees to create a first signal.

18. A method as claimed in claim 1, wherein the modulated signal includes a sum of the carrier signal and an attenuated quadrature carrier signal which is modulated with the data signal.

19. A method as claimed in claim 16, wherein a phase shifter controlled by the data signal is used to provide the phase deviation.

20. A method as claimed in claim 19, wherein the phase shifter is a delay line.

21. A method as claimed in claim 19, wherein the phase shifter is a tuned circuit.

22. A method as claimed in claim 19, wherein the phase shifter is an RC circuit.

23. A method as claimed in claim 1, wherein imposing a phase modulation includes imposing a phase modulation on the carrier signal in accordance with the data signal to create the modulated signal having a carrier and sidebands, the amount of phase modulation being selected such that the amplitude of the sidebands is substantially lower than that of the carrier

24. A method as claimed in claim 23, wherein the phase modulation is less than 90° on the carrier signal.

25. A method as claimed in claim 23, wherein the phase modulation is selected such that the sidebands are greater than 10 dB below the carrier amplitude.

26. A method as claimed in claim 23, wherein the phase modulation is selected such that the sidebands are greater than 20 dB below the carrier amplitude.

27. A method as claimed in claim 23, wherein the phase modulation is selected such that the sidebands are greater than 30 dB below the carrier amplitude.

28. A method as claimed in claim 23, wherein the phase modulation is selected such that the sidebands are greater than 40 dB below the carrier amplitude.

29. A method as claimed in claim 23, wherein the phase modulation is selected such that the sidebands are greater than 60 dB below the carrier amplitude.

30. A method as claimed in claim 23, wherein the modulated signal is created such that sidebands of the modulated signal are less than −15 dB below the carrier amplitude.

31. A method as claimed in claim 23, wherein the modulated signal is created such that sidebands of the modulated signal are −40 dB and −60 dB below the amplitude of the carrier signal.

32. A method as claimed in claim 1, wherein the phase modulation is attenuated.

33. A method as claimed in claim 1, wherein the phase modulation is phase reverse keying PRK.

34. A method as claimed in claim 33, wherein for a 20 dB attenuated PRK signal, the phase deviation is 12 degrees.

35. A method as claimed in claim 33, wherein for a 40 dB attenuated PRK signal, the phase deviation is 1.2 degrees.

36. A method as claimed in claim 33, wherein for a 60 dB attenuated PRK signal, the phase deviation is 0.12 degrees.

37. A method as claimed in claim 1, involving high Q antennas.

38. A method as claimed in claim 1, excluding near field communication methods, wherein the method is a wireless local area network method operating up to a range of about 50 m.

39. A method as claimed in claim 1, excluding near field communication methods, wherein the method is a personal area network method operating up to a range of about 2 m.

40. A method as claimed in claim 1, including controlling the modulated signal transmitted such that the data is not able to be extracted, due to noise, by the second wireless communications device when outside a 0.2 m radius.

41. A method as claimed in claim 1, excluding near field communication methods, the method including controlling the modulated signal transmitted such that the data is not able to be extracted, due to noise, by the second wireless communications device when outside a 1 m radius.

42. A method as claimed in claim 1, excluding near field communication methods, the method including controlling the modulated signal transmitted such that the data is not able to be extracted, due to noise, by the second wireless communications device when outside a 5 m radius.

43. A method as claimed in claim 40, wherein said controlling is for the purpose of assisting with providing privacy with respect to the data.

44. A method as claimed in claim 1, excluding near field communication methods, wherein the method is a wireless local area network method and the first and second wireless communications devices respectively comprise first and second local area network devices.

45. A method as claimed in claim 1, excluding near field communication methods, wherein the method is a wireless local area network method and the first and second wireless communications devices respectively comprise first and second personal area network devices.

46. A method as claimed in claim 1, including deriving the modulated signal from the sum of the carrier signal and an attenuated quadrature carrier signal that is modulated with the data signal.

47. A method as claimed in claim 5, wherein a phase locked loop is used to derive the local oscillator signal.

48. A method as claimed in claim 47, wherein the phase locked loop is a low loop bandwidth phase locked loop.

49. A method as claimed in claim 47, wherein a mixer is used in demodulating the first signal.

50. A method as claimed in claim 47, wherein a multiplier is used in demodulating the first signal.

51. A method as claimed in claim 47, wherein a low pass filter is used to filter out high frequency signal components and pass the demodulated data signal.

52. A method as claimed in claim 47, wherein the antenna signal for demodulation is amplified by squaring the signal by a Schmitt trigger device.

53. A method as claimed in claim 48, wherein the phase locked loop is a low bandwidth phase locked loop device.

54. A method as claimed in claim 47, wherein the data is detected using a floating point comparator device.

55. A wireless communications device including:
a first antenna
oscillator means for providing a carrier signal; and
modulation means for imposing a low level phase modulation on the carrier signal in accordance with a data signal to create a modulated signal, the modulation means also for providing the modulated signal to the first antenna for transmission.

56. A wireless communications transmitter adapted to send a short range wireless communication signal to a wireless communications device in an area network, comprising:
a first antenna;
oscillator means for providing a carrier signal;
modulation means for imposing phase modulation on the carrier signal to create a modulated signal; and for providing the modulated signal to the first antenna;
characterized in that the modulation means imposes phase modulation on the carrier signal in accordance with a phase deviation where the phase deviation is in accordance with a data signal.

57. A wireless communications receiver adapted to receive data from a second wireless communications device, the first wireless communications device comprising:
a second antenna, and
receiver means, adapted to derive a second signal indicative of a data signal received by the second antenna in the form of a modulated signal formed by imposing a low level phase modulation on a carrier signal in accordance with the data signal and transmitting the modulated signal from a first antenna.

58. A wireless communications receiver adapted to receive a short range wireless communication in an area network, the device comprising:
an antenna adapted to receive the modulated signal and, in response thereto, produce a first signal,
receiver means adapted to derive from the first signal, a local oscillator signal used to demodulate the first signal and obtain an indicative data signal.

59. A wireless communications device for an area network adapted to receive a modulated signal and derive therefrom a data signal, the device comprising:
an antenna adapted to receive the modulated signal and, in response thereto, produce a first signal,
receiver means adapted to derive from the first signal, a local oscillator signal used to demodulate the first signal and obtain an indicative data signal.

60. A device for demodulating a modulated signal received by the device and deriving therefrom a data signal, the device comprising:
means for receiving the modulated signal and inducing into an antenna of the device, an antenna voltage signal,
means for amplifying the antenna signal
means for providing a portion of the amplified signal to a phase locked loop to filter off sidebands and create a first signal
means for passing another portion of the amplified signal through a delay means and creating a second signal
means for filtering the first and second signals to provide indicative data.

61. A device as claimed in claim 55, wherein the device comprises a personal area network device.

62. A device as claimed in claim 55, wherein the device comprises a local area network device.

63. A device as claimed in claim 55, wherein the device comprises a voice recorder.

64. A device as claimed in claim 55, wherein the device comprises a PDA.

65. A device as claimed in claim 55, wherein the device comprises is a digital camera.

66. A device as claimed in claim 55, wherein the device comprises a headset for audio communications.

67. A device as claimed in claim 55, wherein the device comprises a keyboard.

68. A device as claimed in claim 55, wherein the device comprises a computer pointer device.

69. A device as claimed in claim 55, wherein the device comprises a joystick, mouse or pen.

70. A device as claimed in claim 55, wherein the device comprises a multimedia player.

71. A device as claimed in claim 55, wherein the device comprises a mass storage device.

72. A device as claimed in claim 55, wherein the device comprises a medical device.

73. A device as claimed in claim 55, wherein the device comprises a computer peripheral device.

74. A device as claimed in claim 55, wherein the modulated signal appears as a phase jitter

75. A device as claimed in claim 55, wherein the modulation means imposes phase modulation on the carrier signal in accordance with a phase deviation where the phase deviation is in accordance with the data signal and provides the modulated signal to the first antenna

76. A device as claimed in claim 75, wherein the modulated signal has a quadrature component.

77. A device as claimed in claim 55, wherein the phase deviation is provided by the equation: THETA=arctan (2×Mag(PRK)/Mag(Fc)), where Fc is the carrier signal and PRK is the quadrature component.

78. A device as claimed in claim 77, wherein the quadrature component is derived from a portion of the carrier signal, that is phase shifted 90 degrees to create a first signal.

79. A device as claimed in claim 55, wherein the modulated signal includes a sum of the carrier signal and an attenuated quadrature carrier signal which is modulated with the data signal.

80. A device as claimed in claim 55, wherein the modulation means is a phase shifter.

81. A device as claimed in claim 80, wherein the phase shifter, controlled by the data signal, is used to provide the phase deviation.

82. A device as claimed in claim 80, wherein the phase shifter is a delay line.

83. A device as claimed in claim 80, wherein the phase shifter is a tuned circuit.

84. A device as claimed in claim 80, wherein the phase shifter is an RC circuit.

85. A device as claimed in claim 55, wherein the antenna is a tuneable coil.

86. A device as claimed in claim 85, wherein the antenna is a high Q antenna.

87. A device as claimed in claim 55, wherein the modulation means provides a modulated signal having a carrier frequency and sidebands, the sidebands being substantially lower in amplitude than the carrier frequency.

88. A device as claimed in claim 87, wherein the modulated signal is created such that sidebands of the modulated signal are between −40 dB and −60 dB below the amplitude of the carrier signal.

89. A device as claimed in claim 57, wherein the receiver includes a phase locked loop to derive the local oscillator signal.

90. A device as claimed in claim 89, wherein the phase locked loop is a low loop bandwidth phase locked loop.

91. A device as claimed in claim 89, wherein the receiver includes a mixer in demodulating the first signal.

92. A device as claimed in claim 89, wherein the receiver includes a multiplier in demodulating the first signal.

93. (canceled)

94. (canceled)

95. An apparatus including: processor means adapted to operate in accordance with a predetermined instruction set, said apparatus, in conjunction with said instruction set, being adapted to perform a method as claimed in claim 1.

96. A computer program product including: a computer usable medium having computer readable program code and computer readable system code embodied on said medium for performing a method as claimed in claim 1 in conjunction within a data processing system.

97. A short range wireless communication system having a plurality of wireless communications devices as claimed in claim 55, the system forming an area network.

98. A method of determining reproduction criteria for use in a document management apparatus or system, the method comprising: associating a radio frequency device with a reproducible article; receiving information corresponding to the radio frequency device; and determining reproduction criteria based on the information.

99. A method as claimed in claim 98, wherein the communication is in accordance with claim 1.

100. A reproduction process comprising the steps of:
determining reproduction criteria and claimed in claim 98 or 99, and
operating a reproduction apparatus or system in accordance with the determination.

101. A device adapted to determine reproduction criteria for use in a document management apparatus, the device comprising: a receiver for receiving information corresponding to a radio frequency device that is associated with a reproducible article; and logic means for determining reproduction criteria based on the information.

102. A device as claimed in claim 101, wherein the communication is in accordance with claim 1.

103. A document management apparatus comprising the device as claimed in claim 101 or 102.
